(19) United States
(12) Patent Application Publication
(10) Pub. No.: US 2014/0196401 A1
(43) Pub. Date: Jul. 17, 2014

(54) APPARATUS AND METHOD FOR MOUNTING COVERS AND DEVICES CO-PLANAR WITH WALLS AND OTHER BUILDING SURFACES

(71) Applicant: James L. Burns, Weston, CT (US)

(72) Inventor: James L. Burns, Weston, CT (US)

(21) Appl. No.: 14/239,254

(22) PCT Filed: Aug. 17, 2012
(86) PCT No.: PCT/US12/51500

§ 371 Date: Feb. 17, 2014

Related U.S. Application Data
(60) Provisional application No. 61/524,736, filed on Aug. 17, 2011.

(51) Int. Cl. H02G 3/12; E04B 1/38

(52) U.S. Cl. CPC H02G 3/12; E04B 1/38; H02G 3/121
USPC 52/745.21; 220/3.5; 248/231.91

(57) ABSTRACT

A flush-mount wall plate system for mounting in a building surface includes a wall flange extrusion assembly with a mounting flange portion and an extrusion member portion. The extrusion member portion has a frame defining an aperture, with a front edge of the frame extending away from a front surface of the mounting flange portion by a pre-determined distance. A cover is inserted into the aperture with a front surface of the cover being substantially co-planar with the front edge of the extrusion member portion and the building surface.

### CROSS-REFERENCE TO RELATED APPLICATIONS

This application claims priority to, and the benefit of, U.S. Provisional Patent Application Ser. No. 61/524,736, filed on Aug. 17, 2011, the disclosure of which is incorporated herein by reference in its entirety.

### BACKGROUND

1. Field

The aspects of the disclosed embodiment generally relate to the installation of building services, and in particular to mounting of wall and cover plates for electrical junction and outlet type boxes, air duct register covers and building controls such as thermostats co-planar with the building surfaces.

2. Brief Description of Related Developments

Walls, ceilings and other building surfaces contain numerous apertures for the installation of items such as electrical and audio-visual receptacles, controls and other devices and air ducts. Receptacles, as that term is generally used herein, include items such as electrical outlets and receptacles for switches, plugs, cable television, network, telephone, sound and other audio-visual wiring systems. Devices include items such as standard on-off switches; dimmer switches; timers; thermostats; motion, sound and other security sensors; security controls; speakers; video monitors; and other electrical and audio-visual controls. Air duct apertures include apertures for cold and warm air registers, air returns, ventilation fans and other air circulation systems. A common method for mounting such devices and covers involves cutting a rough aperture in the building surface material that is large enough to accommodate the receptacle, device or duct, finishing the building surface material utilizing paint, tile, or other standard construction practices, and concealing the rough aperture using a cover or device with dimensions that are greater than the aperture, which cover or device is attached such that the cover's or device's rear surface is flush with the finished building surface and the cover's or device's front surface protrudes from the finished building surface.

A variety of covers have been designed for common receptacles and control devices. The simplest form of cover is a single plate attached to the receptacle or control device utilizing one or more exposed screws. Another form of cover, intended to improve the aesthetic appearance, utilizes a backing plate mounted to the receptacle or control device utilizing one or more screws and a decorative cover that attaches to the backing plate without the use of screws.

Another common method of mounting devices and covers in wall apertures is by using a mounting flange with one surface that extends into the building surface aperture and a second surface that extends beyond the dimensions of the aperture parallel to the building surface.

The common element of each of the foregoing covers and devices is that the rear surface of the cover, device or device mounting flange is affixed flush to the finished building surface such that the front surface of the cover, device or device mounting flange protrudes some distance from the finished building surface.

FIG. 1 shows a three-dimensional perspective view of a typical prior art cover installation consisting of a receptacle 2 mounted to the junction box 1 with two screws 3. As shown in this example, the front surface of the junction box 1 is co-planar with the building surface 4 and the receptacle 2 protrudes a distance away from the building surface 4. This prior art one-piece cover 5 is attached to the receptacle 2 with two screws 6. The rear surface of the prior art cover 5 is co-planar with the building surface 4, while the front surface of the cover 5 protrudes away from the building surface 4.

There are many circumstances in which a highly-visible protruding cover or device is undesirable, including in a modern-style structure where clean lines and minimal features are desired or in a historic structure where receptacles, devices and ducts are required but are not consistent with the historic nature of the structure.

There have been attempts to allow covers to be mounted flush with the building surface. One attempt at mounting a receptacle and cover flush with the building surface is shown in U.S. Pat. No. 6,359,219, by Reid et al. However, the '219 patent relies on a custom recessed junction box, increasing its cost and precluding installers from using readily-available, inexpensive junction boxes. Also, the face of the junction box is recessed into the building surface, requiring the use of special installation techniques and precluding the standard practice in new construction of installing the junction box prior to installing the building surface. Furthermore, the '219 patent's wall flange consists of an “L” shape that requires the surrounding building surface be routed out to accept the junction box and wall flange in order for the front of the wall flange to be flush with the finished building surface. This makes the installation difficult and precludes the product's use with certain types of building surfaces that cannot easily be routed out, such as tile, stone, glass or metal. There is also no means of holding the wall flange in place while it is being affixed to the building surface, making it difficult to keep the wall flange level and even with the building surface during installation.

Another attempt at mounting a receptacle and cover flush with the building surface is shown in U.S. Pat. No. 6,931,794 by Burgess. However, one of the drawbacks of the '794 patent is that it does not address a means of protecting the flange area during installation and finishing.

Also shown in prior art patents are receptacle boxes and covers designed for mounting in a floor. Certain of these prior art devices, such as shown in U.S. Pat. No. 6,179,634, by Hull et al., are designed so that the cover is flush with the floor. However, due to the particular requirements associated with floor-mounted receptacles, including that they be watertight and sustain anticipated floor loads, these prior art devices are complicated and expensive. These characteristics limit the use of such devices in situations that do not require the floor mounted cover's special features.

Accordingly, it would be desirable to provide a flush-mount wall plate system that address at least some of the problems identified above.

### SUMMARY

As described herein, the exemplary embodiments overcome one or more of the above or other disadvantages known in the art.

One aspect of the present disclosure relates to a flush-mount wall plate system for mounting in a building surface. In one embodiment, the wall plate system includes a wall flange extrusion assembly with a mounting flange portion and an extrusion member portion. The extrusion member portion has a frame defining an aperture, with a front edge of the frame extending away from a front surface of the mounting flange portion by a pre-determined distance. A cover is inserted into the aperture with a front surface of the cover being substantially co-planar with the front edge of the extrusion member portion and the building surface.

Another aspect of the present disclosure relates to a method of mounting a wall plate system in a building surface, the wall plate system comprising a wall flange extrusion assembly comprising a mounting flange portion and an extrusion member portion, the extrusion member portion having a frame defining an aperture and a front edge of the frame extending away from a front surface of the mounting flange portion by a pre-determined distance, and a cover inserted into the aperture, a front surface of the cover being substantially co-planar with the front edge of the extrusion member portion and the building surface. In one embodiment, the method includes affixing the wall flange extrusion assembly over a junction box mounting aperture in the building surface; mounting the cover over the aperture, the cover comprising a temporary cover with a raised flange portion on a front surface of the temporary cover surrounding an opening in the temporary cover that substantially aligns with the aperture; blending the mounting flange portion of the wall flange extrusion assembly into the building surface, wherein the front edge of the frame of the extrusion member portion is substantially co-planar with the building surface; removing the temporary cover; and inserting the final cover into the aperture, a front surface of the final cover being substantially co-planar with the front edge of the frame of the extrusion member portion and the building surface.

A further aspect of the present disclosure relates to a kit of parts for installing a flush-mounted device in a surface of a building structure. In one embodiment, the kit comprises a wall flange extrusion assembly comprising a mounting flange portion and an extrusion member portion, the extrusion member portion having a frame defining an aperture and a front edge of the frame extending away from a front surface of the mounting flange portion by a pre-determined distance; and a cover configured to be inserted into the aperture.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the present disclosure, and together with the general description given above and the detailed description given below, serve to explain the principles of the present disclosure. As shown throughout the drawings, like reference numerals designate like or corresponding parts.

FIG. 1 is a perspective cut-away view of a typical prior art electrical outlet and cover.

FIG. 2 is a perspective cut-away view of one embodiment of a wall plate assembly incorporating aspects of the present disclosure mounted in a building surface.

FIG. 3 illustrates a perspective view of one embodiment of a wall flange extrusion assembly incorporating aspects of the present disclosure.

FIG. 4 illustrates a perspective view of one embodiment of a wall flange extrusion assembly incorporating aspects of the present disclosure.

FIG. 5 illustrates a perspective view of one embodiment of a wall flange extrusion member incorporating aspects of the disclosed embodiments.

FIG. 6 illustrates a perspective view of one embodiment of a wall flange mounting member incorporating aspects of the disclosed embodiments.

FIG. 7 is a perspective view of one embodiment of a temporary cover incorporating aspects of the present disclosure.

FIG. 8 is a perspective view of one embodiment of a final cover incorporating aspects of the present disclosure.

FIG. 9 is a three-dimensional cut-away view of the one embodiment of the present disclosure mounted in a building surface.

FIG. 10 is a three-dimensional cut-away view of one embodiment of the present disclosure mounted in a building surface constructed of a mounting substrate and finished building surface material such as tile.

FIG. 11 is a perspective view of one embodiment of a wall flange mounting member incorporating aspects of the present disclosure.

FIG. 12 is a perspective view of one embodiment of a wall flange extrusion member incorporating aspects of the present disclosure.

FIG. 13 illustrates one embodiment of a kit incorporating aspects of the present disclosure.

FIG. 14 illustrates another embodiment of a kit incorporating aspects of the disclosed embodiments.

FIG. 15 illustrates one embodiment of a wall flange extrusion assembly incorporating aspects of the present disclosure including a temporary cover and thermostat.

FIG. 16 illustrates one embodiment of a wall flange extrusion assembly incorporating aspects of the present disclosure including a temporary cover and air duct cover.

### DETAILED DESCRIPTION OF THE DISCLOSED EMBODIMENTS

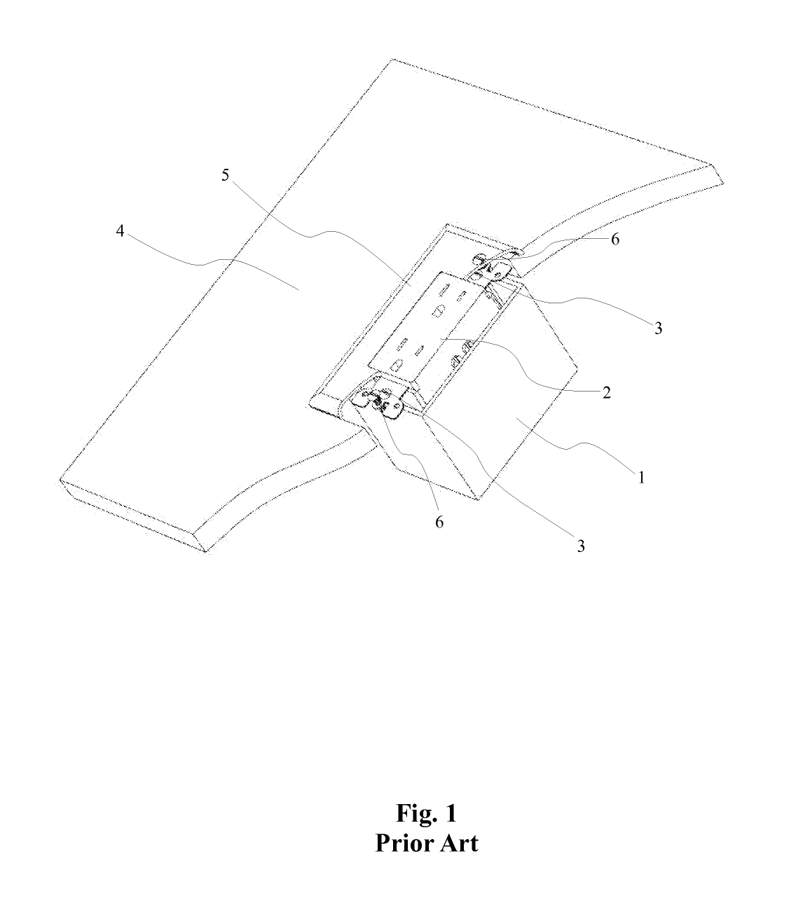

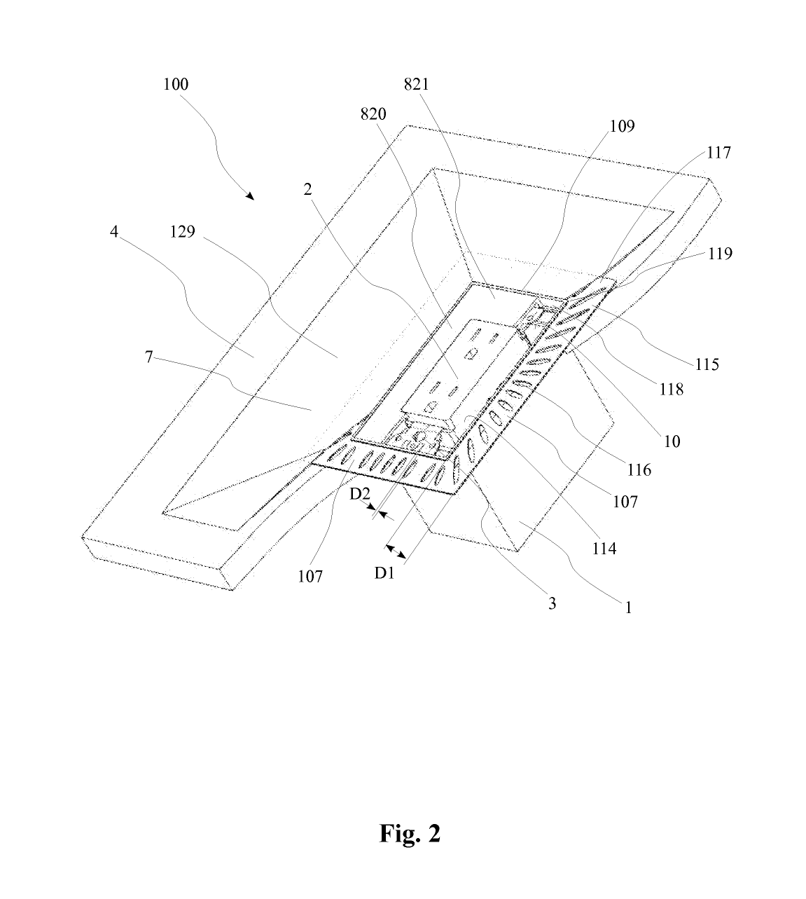

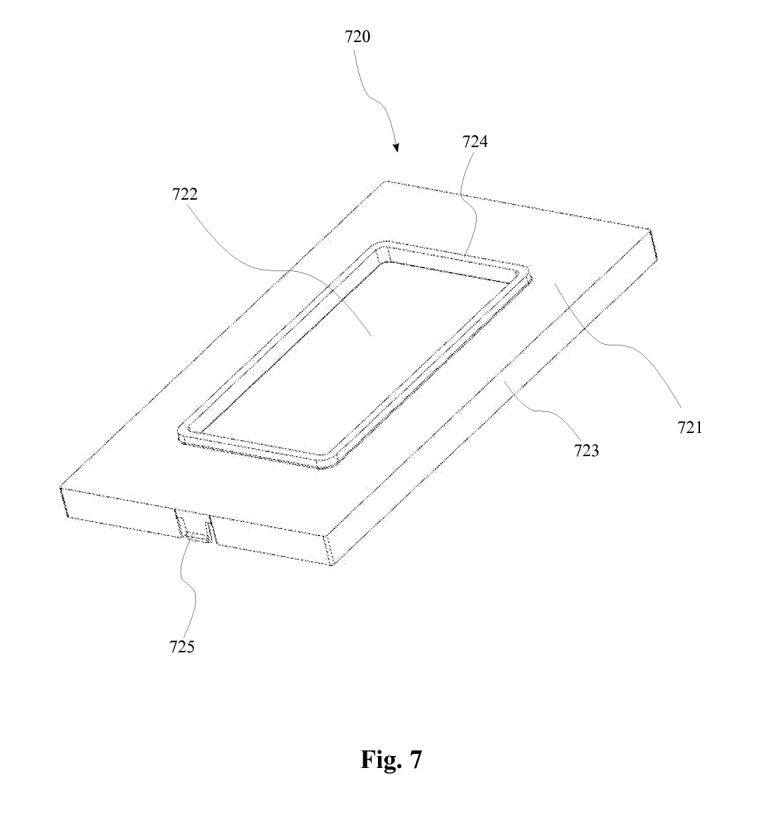

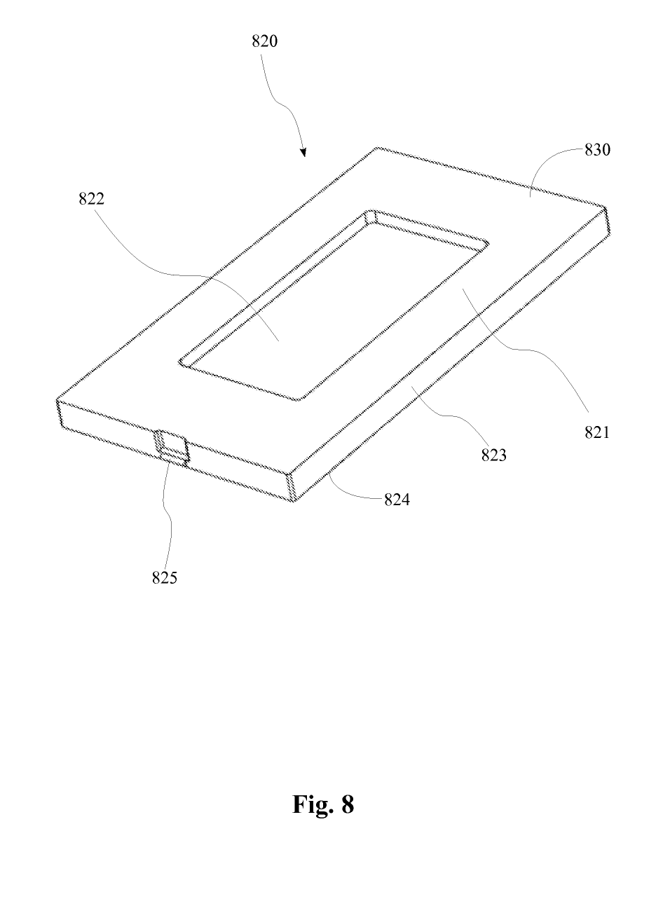

Referring to FIG. 2, one embodiment of a wall plate system incorporating aspects of the present disclosure is generally designated by reference numeral 100. The aspects of the disclosed embodiments are directed to a wall plate system that includes a wall flange extrusion assembly 107 and one or more of a temporary cover 720 (shown in FIG. 7) and a final cover 820 (shown in FIG. 8). In the example of FIG. 1, the final cover 820 is shown installed in the wall flange extrusion assembly 107. The wall plate system 100 of the disclosed embodiments allows for installation of the wall flange extrusion assembly 107 in apertures in walls and other building surfaces in conjunction with standard or existing electrical junction, switch and outlet boxes, such that the front surface 821 of the final cover 820 is substantially co-planar, or flush mounted, with the exposed building or wall surface 4.

In the example shown in FIG. 2, the wall plate system 100 is mounted to or in a building surface 4, such as a wall. The building surface 4 in this example is constructed of a building material such as dry wall that is finished using a malleable compound to smooth the building surface 4. In the examples described herein, the malleable compound will be referred to as common joint compound, although any such suitable building material may be used. For purposes of the description herein, the building surface 4 will generally be referred to as a wall, although the aspects of the disclosed embodiments are intended to encompass any building surface in which a receptacle, such as for an electrical junction box 1, can be disposed, including for example, a ceiling or floor structure. For example, the aspects of the disclosed embodiments can also find application in the mounting of devices such as air ducts, thermostats, speakers, lighting controls, alarm sensors, infrared sensors, alarm system control panels, or any other device that is mounted in a wall, ceiling or other building surface where such devices may be located.

In the example of FIG. 2, a receptacle 2, in the form of an electrical outlet, and a wall flange extrusion assembly 107 are shown mounted in or attached to the junction box 1, using for example, mounting screws 3. The junction box 1, for purposes of the description herein, is generally a common type of junction box that is used to house and mount devices, such as electrical plugs, switches and other such devices. In one embodiment, the wall flange extrusion assembly 107 includes a mounting flange portion 115 and an extrusion member portion 118. The mounting flange portion 115 is configured to be aligned or disposed substantially flush with or on the building surface 4. The extrusion member portion 118 extends into an aperture or opening 10 in the building surface 4, in a manner or orientation that is substantially perpendicular to or from the mounting flange portion 115. A frame 119 of the extrusion member portion 118 defines an aperture 114. In one embodiment, a front edge or surface 109 of the extrusion member portion 118, in particular the frame 119, extends away from a front surface 117 of the mounting flange portion 115 by a pre-determined distance D2.

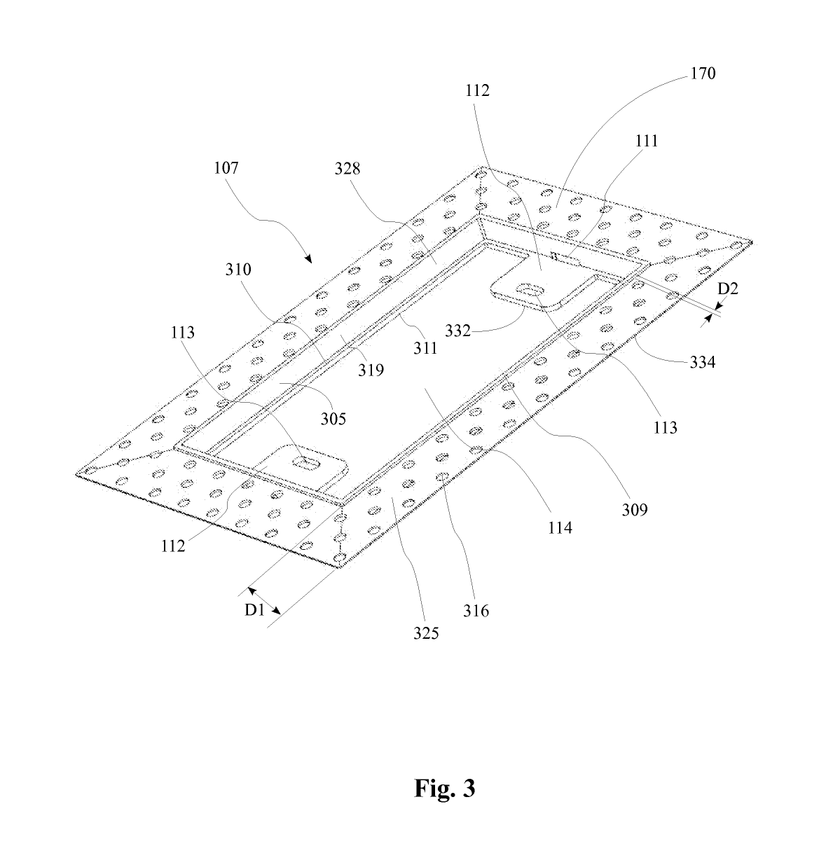

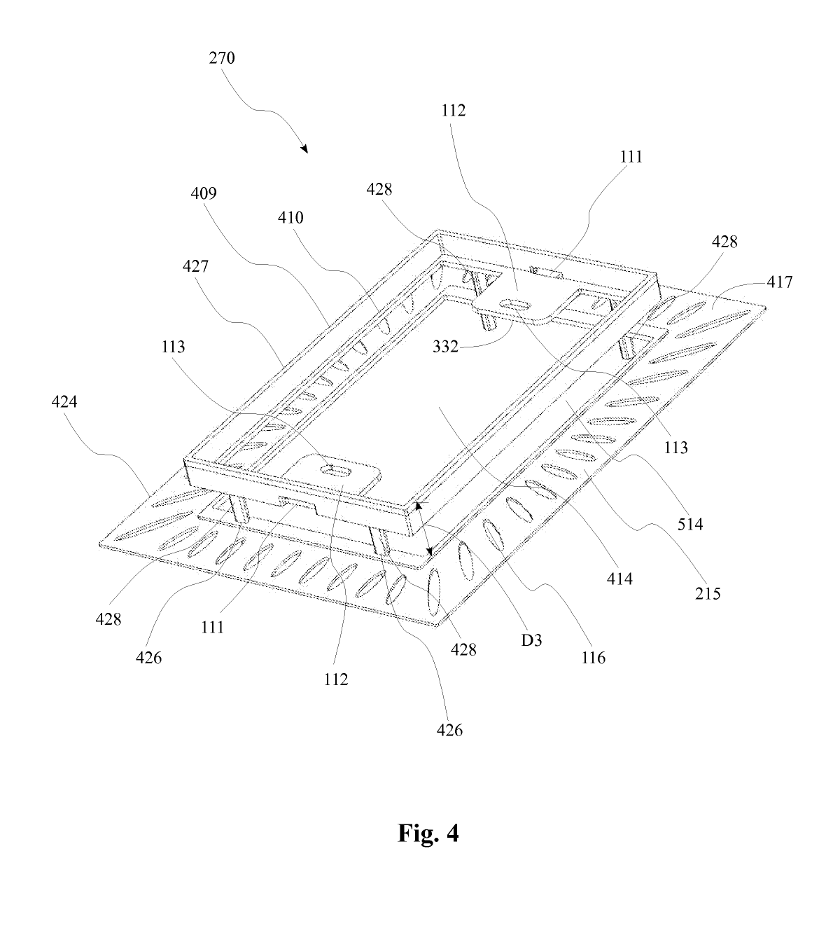

In one embodiment, the mounting flange portion 115 and extrusion member portion 118 of the wall flange extrusion assembly 107 are integrated into a single integrated component assembly 170 such as that shown in FIG. 3. Alternatively, the mounting flange portion 115 and extrusion member portion 118 of wall flange extrusion assembly 107 comprise two separate components that are connected during installation, such as the assembly 270 shown in FIG. 4.

In one embodiment, a final cover 820 is inserted into the aperture 114 of the wall flange extrusion assembly 107, generally referred to herein as the wall flange aperture 114. The front surface 821 of the final cover 820 is substantially co-planar with the front edge or surface 109 of the wall flange extrusion assembly 107 and exposed face 7 of the building surface 4.

In the exemplary embodiment of FIG. 2, the mounting flange portion 115 of the wall flange extrusion assembly 107 is blended into the building surface 4 using a finishing material 129, such as joint compound, so that the front surface 109 of the wall flange extrusion assembly 107 appears co-planar with the exposed face 7 of the building surface 4, as modified by the finishing material 129. In one embodiment, the mounting flange portion 115 of wall flange extrusion assembly 107 includes one or more openings 116 to aid in securing the wall flange extrusion assembly 107 to the building surface 4 utilizing, for example, the finishing material 129. In alternate embodiments, the wall flange extrusion assembly 107 is affixed to the building surface 4 by holding the wall flange extrusion assembly 107 in place using means such as screws, tabs, clips, or glue, while being permanently affixed to the building surface 4 using the appropriate affixing or finishing material based on the type of building surface 4.

The extrusion member portion 118 of the wall flange extrusion assembly 107 is sized to accommodate the receptacle 2. In one embodiment, the dimensions of the wall flange extrusion assembly 107, temporary cover 720 and final cover 820 are dictated by the dimensions of the receptacle 2 or device. For example, a common electrical receptacle 2 would require that the outside dimensions of the final cover 820 be a minimum of approximately 4.5 inches by 2.75 inches and that the aperture 822, shown in FIG. 8, in the final cover 820 be approximately 2.6 inches by 1.3 inches. As another example, a common air duct would require that the inside dimensions of the aperture 114 of the wall flange extrusion assembly 107 be approximately 7.5 inches by 11.5 inches. However, the aspects of the embodiments disclosed herein can be sized to fit any size or shape recessed junction box and any size or shape receptacle or control device. In addition, the aspects of the disclosed embodiments can be applied to recessed junction boxes that house multiple receptacles or devices.

While the junction box 1 referred to herein is generally described as a component separate from the wall flange extrusion assembly 107, in one embodiment, the junction box 1 is integrated with the wall flange extrusion assembly 107. In this embodiment, the wall flange extrusion portion 118 is of adequate length to accommodate a receptacle 2 or device. The integrated junction box 1 would be of a shape, and contain rear or side access points, consistent with common recessed boxes.

The wall plate system 100 of the disclosed embodiments can be made from any type of material commonly used in the industry to manufacture covers. The types of materials for the wall flange extrusion assembly 107 include, but are not limited to, plastics and ferrous or non-ferrous metals that are compliant with applicable building standards and codes. Materials for the covers 720, 820 or other device mounted in the wall flange extrusion assembly 107 can include, but are not limited to, plastics, ferrous or non-ferrous metals, or materials such as wood, stone or glass that are compliant with applicable building standards and codes.

The wall flange extrusion assembly 107, temporary cover 720 and final cover 820 can be manufactured using any suitable manufacturing technique commonly known in the industry such as, but not limited to, injection molding, stamping, welding, machining or cutting.

As is shown in FIG. 2, the mounting flange portion 115 extends away from the extrusion member portion 118, in a substantially perpendicular orientation, a distance D1. The distance D1, which can be any suitable distance, is generally sufficient to permit the wall flange extrusion assembly 107 to be securely attached to the building surface 4.

In the embodiment shown in FIG. 2, the front surface or edge 109 of the extrusion member portion 118 extends away from the front surface 117 of the mounting flange portion 115 in a direction that is substantially perpendicular to the mounting flange portion 115. In one embodiment, there is a distance D2 between the front surface 117 of the mounting flange portion 115 and the front surface 109. This allows the mounting flange portion 115 to be blended into the building surface 4 utilizing the finishing material 129 such that upon installation the front or exposed face surface 7 of the building surface 4 is or appears substantially co-planar with the front surface 109 of the extrusion member portion 118.

Referring to FIG. 3, in one embodiment, the wall flange extrusion assembly 107 comprises an integrated one-piece wall flange extrusion assembly 170. As shown in FIG. 3, the one-piece wall flange extrusion assembly 170 includes a mounting flange portion 325 and an extrusion portion 328, similar to the mounting flange portion 115 and extrusion member portion 118 shown in FIG. 2. In this example, the extrusion portion 328 is configured to be disposed in a substantially recessed manner in the mounting flange portion 325, as will be described herein.

In the example of FIG. 3, the mounting flange portion 325 includes openings 316 to aid in securing the mounting flange portion 325 to a building surface 4. Although the shape of the openings 316 shown in FIG. 3 are substantially circular, in alternate embodiments, the shape of the openings 316 can be any suitable shape, such as those shown in FIGS. 2 and 4.

In the embodiment shown in FIG. 3, the extrusion member portion 328, similar to the extrusion member portion 118 of FIG. 2, includes a front surface or edge 309 and a rear flange member 310, also referred to herein as a stop member. In one embodiment, a first end 311 of the rear flange member 310 extends substantially perpendicularly away from the inner side or surface 305 of the frame 319 of extrusion member portion 328, the frame 319 defining the extrusion aperture 114. The rear flange member 310 provides a stop for the temporary cover 720 shown in FIG. 7 or the final cover 820 shown in FIG. 8. The rear flange member 310 controls the depth of the temporary cover 720 or final cover 820 so that the front surfaces 721, 821 of the respective covers 720, 820 are substantially co-planar with the front surface or edge 309 of the extrusion member portion 328.

In one embodiment, the extrusion member portion 328 includes openings or recesses 111 in at least two locations on the inner side or surface 305 of the extrusion member portion 328. In the example of FIG. 3, the openings or recesses 111 are part of the rear flange member 310 for the purpose of receiving tabs 725, 825 shown in FIGS. 7 and 8, in the covers 720, 820, respectively, to secure the cover to the wall flange extrusion assembly 170.

In one embodiment, the wall flange extrusion assembly 107 has surfaces 112 extending into the aperture 114 of the extrusion 328, which surfaces 112 are referred to herein as the rear mounting flanges 112. The rear mounting flanges 112, which in this example extend outwardly or away from the rear flange member 310 into the aperture 114, permit the wall flange extrusion assembly 107 to be attached or secured to the junction box 1. In one embodiment, the rear mounting flanges 112 include openings or holes 113 that permit the wall flange extrusion assembly 107 to be affixed to a recessed junction box 1 utilizing screws 3 extending through the rear mounting flanges 112 and into threaded holes common to all recessed junction boxes, thereby holding the wall flange extrusion assembly 107 in the proper position while the wall flange extrusion assembly 107 is affixed to the building surface 4. In an alternate embodiment, the rear mounting flanges 112 are sized and located to permit the wall flange extrusion assembly 107 to be affixed to an air duct (not shown), thereby holding the wall flange extrusion assembly 107 in the proper position while the wall flange extrusion assembly 107 is affixed to the building surface 4. In one embodiment, the holes 113 in the rear mounting flanges 112 are threaded holes such that the receptacle 2 or other device can be affixed to the wall flange extrusion assembly 107 rather than to a junction box 1.

Referring to FIG. 4, in one embodiment, the wall flange extrusion assembly 107 comprises a two-piece wall flange extrusion assembly 270. In this example, the two-piece wall flange extrusion assembly 270 comprises a mounting flange member 424 and an extrusion member 427 that are coupled together during installation. The extrusion member 427 is configured to be slidingly engaged with or affixed to the mounting flange member 424 at varying distances D3 from the front surface or first end 409 of the extrusion member 427. In the embodiment shown in FIG. 4, slots 426 in the mounting flange member 424 slidingly engage the mounting posts 428 on the extrusion member 427. The mounting posts 428 align with and insert into the slots 426. The slots 426 and mounting posts 428 permit the mounting flange member 424 to be affixed to the extrusion member 427 such that the distance D3 from the first end 409 of the extrusion member 427 and the front surface 417 of the mounting flange member 424 substantially match the approximately thickness of the finished building surface material.

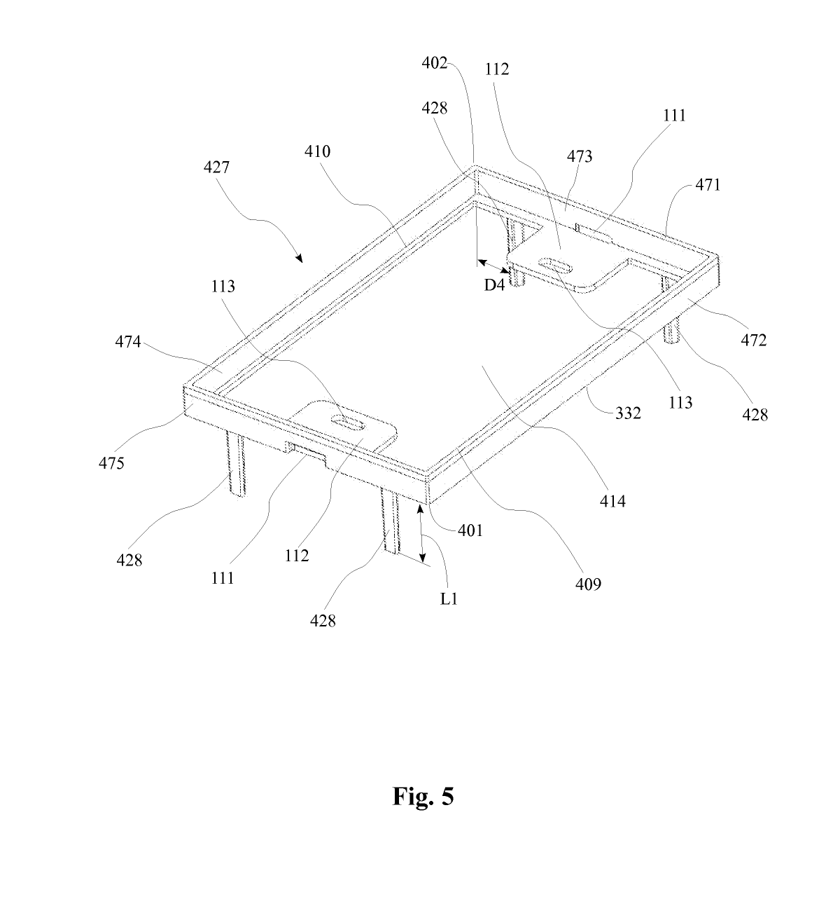

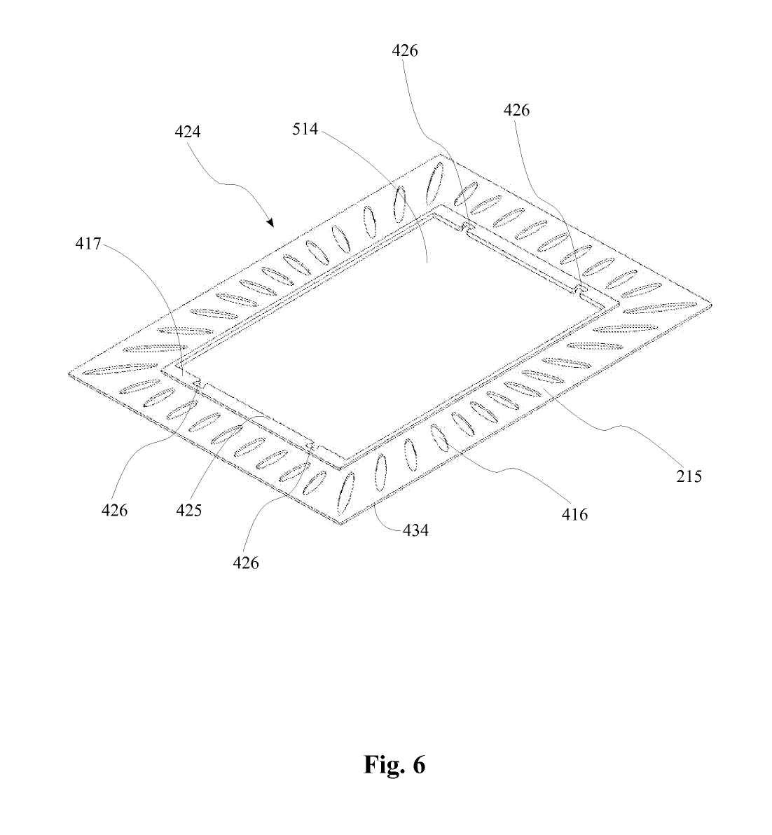

In one embodiment, referring to FIG. 5, the extrusion member 427 has a frame 471, similar to the frame 119 of FIG. 2, with side portions 472, 473, 474 and 475. The side portions 472, 473, 474 and 475 of the frame 471 define an aperture 414. The mounting flange member 424 defines an aperture 514 (shown in FIG. 6) that substantially aligns with aperture 414. The apertures 414 and 514 generally comprise aperture 114 referred to in FIGS. 2 and 3. The frame 471 also includes a front surface or edge 409 and a rear flange member or stop member 410, substantially the same as front surface 309 and rear flange member 310 of FIG. 3. The rear flange member 410 is disposed along the second end or rear edge 332 of each side portion 472, 473, 474 and 475 of the frame 471. As shown in FIG. 5, the rear flange member 410 is substantially continuous along the second end 332 of each of the side portions 472, 473, 474 and 475 of the frame 471.

In one embodiment, the extrusion member 427 includes recesses 111 that are disposed in an outer facing portion of each of the side portions 473, 475. The recesses or openings 111 can be used for mounting the temporary cover 720 or final cover 820 to the extrusion member 427.

In the embodiment shown in FIGS. 4 and 5, mounting flanges 112 extend from the rear flange member 410 on side portions 473, 475 of the frame 471. The mounting flanges 112 include the mounting holes 113 for attaching the extrusion member 427 to, for example, a junction box 1, as is shown in FIG. 2.

Referring to FIG. 5, in one embodiment, the extrusion member 427 includes mounting posts 428. The mounting posts 428 are disposed on a rearward side 401 of the extrusion member 427 in a substantially orthogonal manner, or so that each mounting post 428 extends away from the extrusion member 427. In the embodiment shown in FIG. 5, the extrusion member 427 includes four mounting posts 428. In alternate embodiments, any suitable number of mounting posts 428 can be included, including more or less than four. For example, it could be advantageous to use only two mounting posts 428, the two mounting posts 428 being diagonally opposed to one another.

As shown in FIG. 5, each mounting post 428 is disposed in a corner region of the extrusion member 427. In the embodiment shown in FIG. 5, each mounting post 428 is a distance D4 from the corner 402 of the extrusion member 427. In one embodiment, this distance D4 can be in the range of approximately 0.25 to 0.5 inches, depending upon the size of the extrusion member 427. In alternate embodiments, the distance D4 can be any suitable distance including less than 0.25 inches or greater than 0.5 inches. In one embodiment, a length L1 of each mounting post 428 is in the range of approximately 0.5 to 1.5 inches. In alternate embodiments, length L1 of each of the mounting posts 428 can be any suitable length. In addition, the mounting posts 428 can be either permanently affixed to the extrusion member 427 or may be removably affixed to the extrusion member 427 by threading one end of the mounting posts 428 and including threaded holes in the extrusion member 427 located and sized to accept the mounting posts 428 or by affixing the mounting posts 428 to the extrusion member 427 using a snap-fit type connection. The mounting posts 428 are configured to be removably received or disposed in slots 426, shown in FIG. 4, in the mounting flange member 424 of the two-piece wall flange extrusion assembly 270.

Referring to FIG. 6, in one embodiment the mounting flange member 424 includes slots 426 which slots align with the mounting posts 428 of the extrusion member 427. In this example, the mounting flange member 424 can be positioned and secured to the building surface 4, as is generally described herein. The extrusion member 427 can then be slidingly engaged with the primary mounting flange member 424. The sliding engagement of the mounting posts 428 in the slots 426 allows the extrusion member 427 to be positioned at any desired distance from the primary mounting flange member 424. In one embodiment, when the desired position is achieved, the mounting posts 428 can be secured in the slots 426 using, for example, a fast-acting glue. Alternatively, the mounting post 428 and slot 426 are configured for a friction-type engagement, to hold the extrusion member 427 in the desired position.

FIG. 7 is a perspective view of one embodiment of a temporary cover 720 that can be used with the wall plate system 100 of FIG. 2. In this embodiment, the temporary cover 720 includes a front surface 721, an aperture 722, side surfaces 723, a raised flange portion 724 and one or more mounting tabs 725. The mounting tabs 725 are utilized to secure the temporary cover 720 to the wall flange extrusion assembly 107.

FIG. 8 is three-dimensional perspective view of one embodiment of the final cover 820 shown in FIG. 2. In this example, the final cover 820 includes a front surface 821, an aperture 822, side surfaces 823 and one or more mounting tabs 825 utilized to secure the final cover 820 to the wall flange extrusion assembly 107. In one embodiment for use in conjunction with receptacles 2 or devices, the cover 820 comprises a membrane 830 sized to fit inside the aperture 114 of the wall flange extrusion assembly 107, which membrane has an aperture 822 that corresponds in size to the dimensions of the receptacle 2 or device. The side surfaces 823 of the membrane extend substantially perpendicularly from the rear surface 824 of the membrane 830.

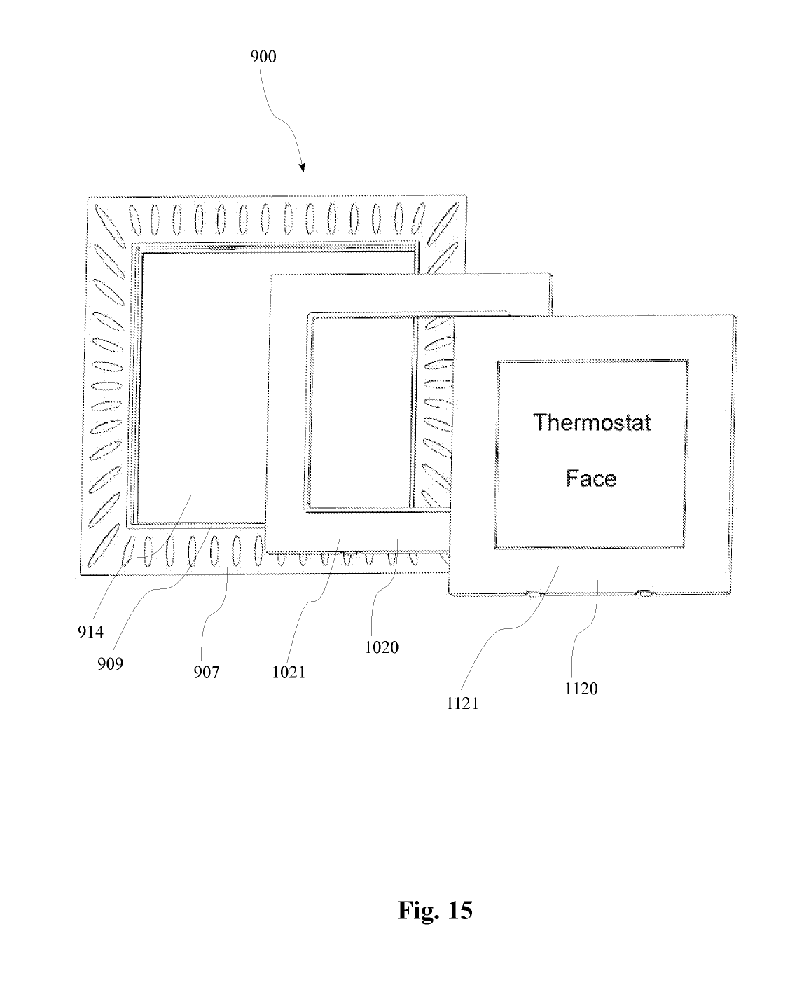

In an embodiment for use with self-contained devices such as thermostats, as shown for example in FIG. 15, the temporary cover 1020 device 1120 are configured and sized to fit inside the aperture 914 of the wall flange extrusion assembly 907 as is generally described herein with respect to FIGS. 2-8. The front face 1021 and 1121 of the temporary cover 1020 and device 1120, respectively, are configured to align with the front surface 909 of the wall flange extrusion assembly 907.

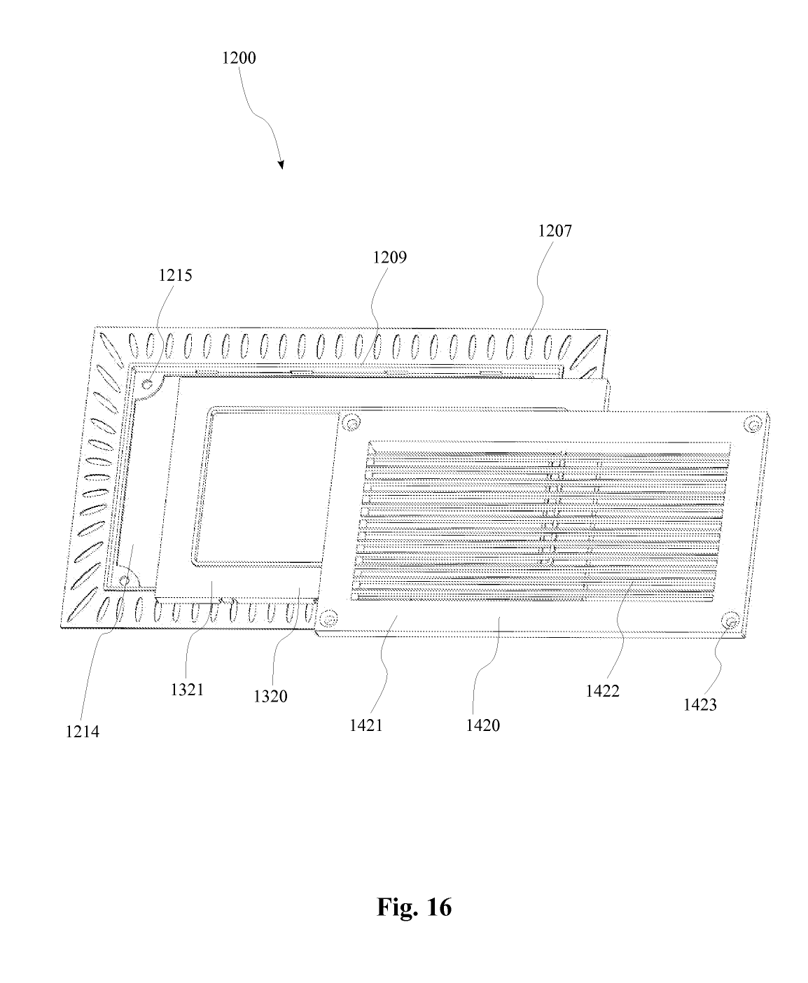

In an alternative embodiment for use with air ducts, as shown for example in FIG. 16, the cover 1420 comprises a membrane that has a plurality of holes or slots 1422 generally consistent with commonly available air duct register covers. The temporary cover 1320 and air duct register cover 1420 are sized to fit inside the aperture 1214 of the wall flange extrusion assembly 1207 as is generally described herein with respect to FIGS. 2-8. The front face 1321 and 1421 of the temporary cover 1320 and air duct register cover 1420, respectively, are configured to align with the front surface 1209 of the wall flange extrusion assembly 1207.

The temporary cover 720 and the final cover 820 are described as being attached to the wall flange extrusion assembly 107 by causing tabs 725, 825 to protrude outward, substantially perpendicularly from the sides of the cover 720, 820, respectively, and be received in corresponding recesses 111 in the wall flange extrusion assembly 107, thereby permitting the cover 720 or 820 to be attached to and removed from the wall flange extrusion assembly 107 in a manner consistent with a typical method of connecting plastic components without the use of screws or other hardware. In alternate embodiments, the cover 720 or 820 can also be attached to the wall flange extrusion assembly 107 utilizing other snap-fit designs or other fasteners. In one embodiment, the cover 720, 820 also can be attached to the wall flange extrusion assembly 107 by affixing a backing plate to the recessed junction box 1, which backing plate is smaller in area than the aperture 114 of the wall flange extrusion assembly 107, and contains an aperture larger than the receptacle 2 or control device. The cover 720, 820 or other device (speaker, air duct register cover, thermostat) is attached to the backing plate with either tabs or screws, thereby eliminating the need to affix the cover 720, 820 to the wall flange extrusion assembly 107. In the embodiment shown in FIG. 16, the cover 1420 includes apertures 1423 configured to receive fastening devices such as screws (not shown). The screws can engage corresponding openings 1215 in the wall flange extrusion assembly 1207.

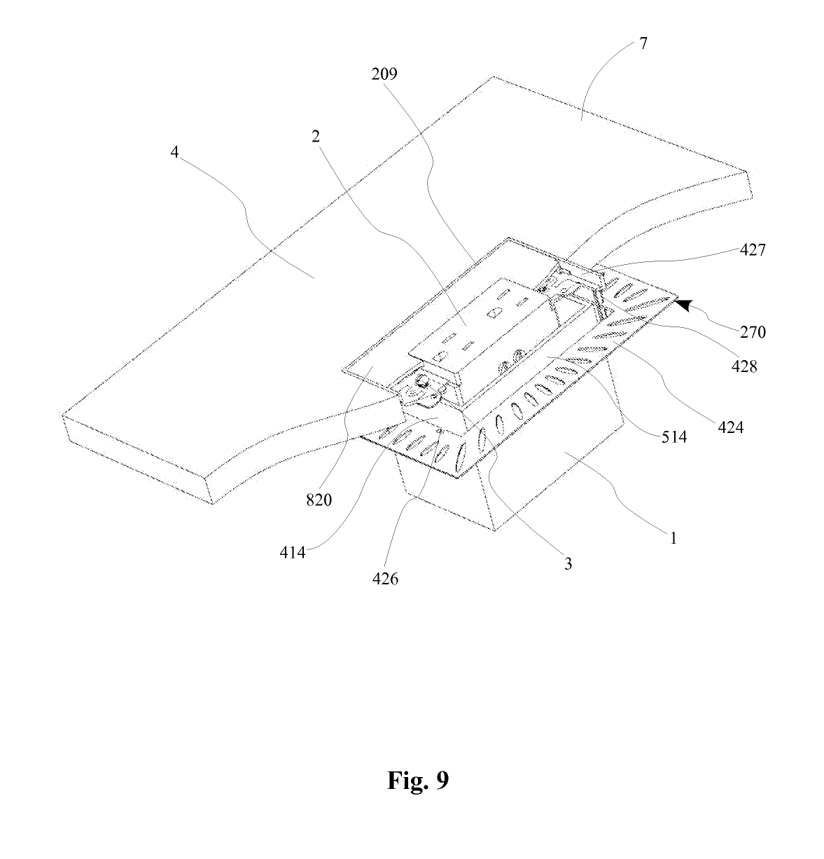

FIG. 9 is a three-dimensional sectional view of one embodiment of the wall plate system 100 as installed on a pre-finished building surface 4 such as wood. In this example, the wall flange extrusion assembly 107 is a two-piece wall flange extrusion assembly 270. As is shown in FIG. 9, the mounting flange member 424 of the two-piece flange extrusion assembly 270 is attached to the unexposed side of the building surface 4. The extrusion member 427 is inserted into the aperture 10 in the building surface 4 such that the front surface 409 of the extrusion member 427 is substantially co-planar with the exposed face 7 of the building surface 4. The extrusion member 427 is coupled to the mounting flange member 424 by inserting or sliding the extrusion mounting posts 428 into the flange slots 426. The extrusion member 427 is slidably engaged with the mounting flange member 424. The position of the extrusion member 427 relative to the exposed face 7 of the building surface 4 can be adjusted so that the front surface 209 of the extrusion member 427 is substantially co-planar with the face 7 of the building surface 4. A receptacle 2 is inserted into the aperture 414 of the extrusion member 427 and aperture 514 of the mounting flange member 424. The receptacle 2 and the extrusion member 427 are connected to the junction box 1 using mounting screws 3. In one embodiment, a final cover 820 is inserted into the extrusion aperture 414. In this position, the front surface 821 of the final cover 820 is substantially co-planar with the front surface 209 of the extrusion member 427.

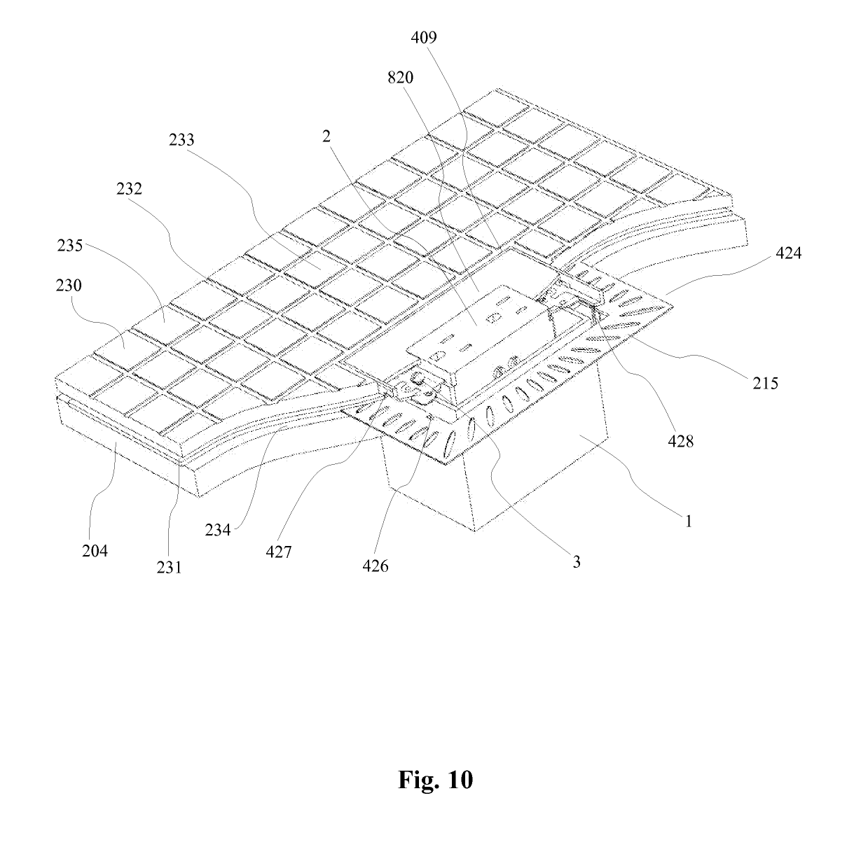

FIG. 10 is a three-dimensional sectional view of one embodiment of the wall plate system 100 as installed on a building surface 4 that includes a finished building surface material 230 on top of or over the mounting substrate 204. An example of such an installation can include tile 233 that is affixed to the mounting substrate 204 using a finish surface attachment means 231, such as mastic, and further finished using a finish surface filler material 232 such as grout. In this embodiment, the mounting flange member 424 of the two-piece wall flange extrusion assembly 270 is attached to the face 234 of the mounting substrate 204. The extrusion member 427 is slidingly engaged or coupled to the mounting flange member 424 by inserting the extrusion mounting posts 428 into the flange slots 426. The extrusion member 427 is slidingly positioned such that the front surface 409 of the extrusion member 427 is substantially co-planar with the outer surface or face 235 of the finished building surface material 230. A receptacle 2 is inserted into aperture 414 of the two-piece wall flange extrusion assembly 270 and the receptacle 2 and extrusion member 427 are connected to the junction box 1 using mounting screws 3. In this example, a final cover 820 is inserted into the extrusion aperture 414 such that the front surface 821 of the final cover 820 is substantially co-planar with the front surface 409 of the extrusion member 427.

In the embodiment of FIG. 2, where the wall flange extrusion assembly 107 comprises a single piece or integrated wall flange extrusion assembly 170, the wall flange extrusion assembly 170 is installed by affixing the primary mounting flange portion 325 to the building surface 4 utilizing a finishing material such as joint compound or a combination of joint compound and joint tape.

In the embodiment of FIG. 10, where the wall flange extrusion assembly 107 comprises a two-piece wall flange extrusion assembly 270, the two-piece wall flange extrusion assembly 270 is installed by affixing the mounting flange member 424 to the rear surface 234 of the finished building surface material 235 such as tile, stone, wood, glass, metal, concrete or other solid surface material utilizing an affixing material such as mastic, glue or screws, and then connecting the extrusion member 427 to the mounting flange member 424.

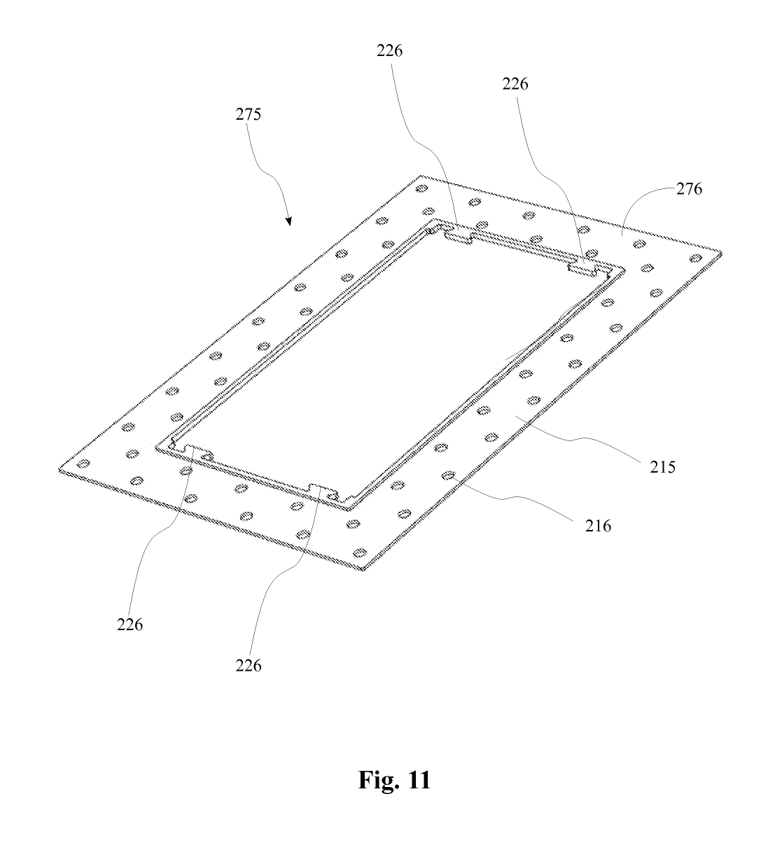

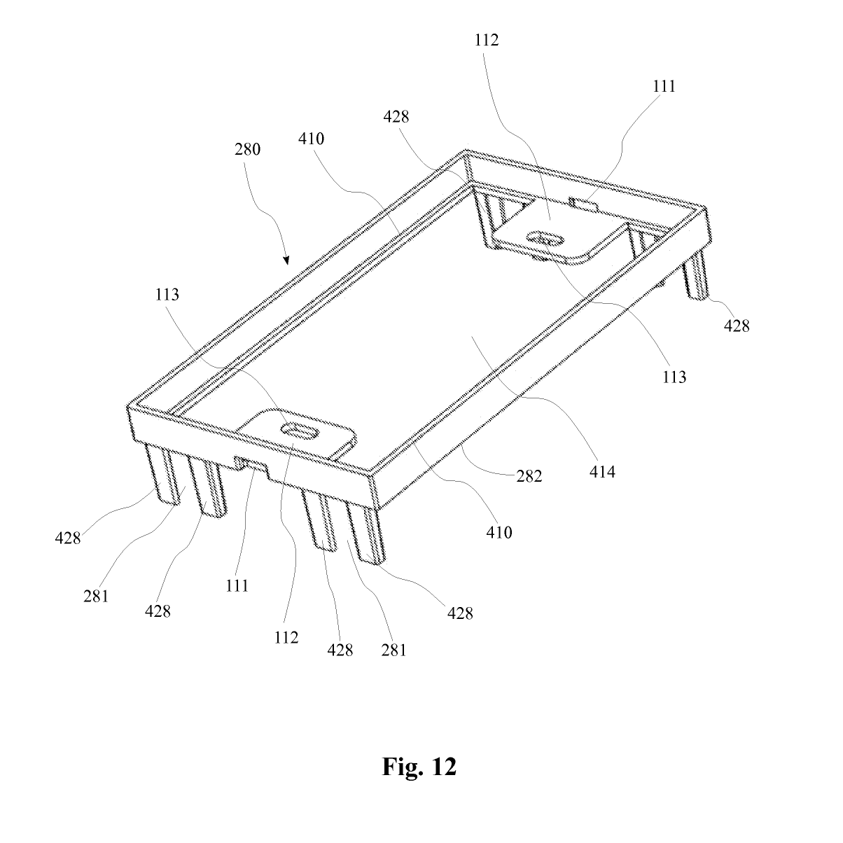

Referring to FIGS. 11 and 12, one embodiment of the two-piece wall flange extrusion assembly includes an extrusion member 280 and a mounting flange member 275. In this embodiment, the extrusion member 280 includes slots 281 in the extrusion member 280 defined by pairs of legs or posts 428 and tabs 226 on the mounting flange member 275, which tabs 226 align with and insert into the slots 281 in the extrusion member 280. The slots 281 and tabs 226 permit the mounting flange member 275 to be affixed to the extrusion member 280 such that the distance from the first end 409 of the extrusion member 280 and the front surface 276 of the mounting flange member 275 substantially match the approximate thickness of the finished building surface material 4.

During the installation of the wall plate assembly 100 of FIG. 2, it may be necessary for the building surface 4 to be finished after the installation of the wall flange extrusion assembly 107. In one embodiment, the temporary cover 720 is installed into the aperture 114 of the wall flange extrusion assembly 107. In this embodiment, the temporary cover 720 is sized to fit inside the aperture 114 of the wall flange extrusion assembly 107, such that the front surface 721 of the temporary cover 720 is substantially co-planar with the front surface 109 of the extrusion portion 118 of the wall flange extrusion assembly 107. The temporary cover 720 is removably affixed the wall flange extrusion assembly 107 by, for example, tabs 725 to permit the temporary cover 720 to be removed from the wall flange extrusion assembly 107 after the building surface 4 is finished.

For example, in one embodiment, the wall flange extrusion assembly 107 comprises a one-piece wall flange extrusion assembly 170. The one-piece wall flange extrusion assembly 170 is installed on a building surface 4 such as gypsum board that is finished using a spreadable finishing compound such as joint compound by using the following steps. First, a recessed junction box 1 is affixed to the building structure, such as common 2×4 studs, utilizing standard construction techniques. The recessed junction box 1 is affixed such that the distance between the front of the junction box 1 and the front of the building surface material 4 approximates, but is not less than, the distance from the rear surface 332 of the rear mounting flanges 112 to the rear surface 334 of the primary mounting flange portion 325, shown in FIG. 3. Second, all other rough construction work is completed that must be completed prior to installing the building surface 4. Third, an aperture 10 is formed in the building surface 4 at the appropriate location for the junction box 1. The dimensions of the aperture 10 must be larger than the outer dimensions of the extrusion portion 328 of the wall flange extrusion assembly 107 but smaller than the outer dimensions of the primary mounting flange portion 325. Fourth, the building surface 4 is affixed to the building structure utilizing standard construction techniques. Fifth, the wall flange extrusion assembly 107 is affixed temporarily to the building surface by leveling the wall flange extrusion assembly 107 against the building surface 4 and then affixing the wall flange extrusion assembly 107 to the recessed junction box 1 utilizing screws inserted through the rear mounting flanges 112 of the wall flange extrusion assembly 107 and into the threaded holes that exist in standard recessed junction boxes. In the alternative, or in addition hereto, the primary mounting flange portion 325 can be affixed to the building surface 4 utilizing adhesive or other fastening devices such as screws, nails or staples. Sixth, a temporary cover 720 is inserted into the wall flange aperture 114 to protect the wall flange aperture 114 and any items in the junction box 1 from any contamination due to the surfacing material, such as the joint compound. Seventh, the primary mounting flange portion 325 is blended into the building surface 4 using standard joint compound or joint compound and joint tape such that the finished building surface 7 is substantially flush with the front edge or surface 109 of the wall flange extrusion portion 118. Eighth, the temporary cover 720 is removed. Ninth, the receptacle 2 or other device, if applicable, is inserted into the wall flange extrusion assembly 107 and attached to the wall flange extrusion assembly 107 and junction box 1. Tenth, the final cover 820 or device is installed in the wall flange aperture 114. Alternatively, the receptacle 2 or other device can be inserted into the wall flange extrusion assembly 107 and attached to the wall flange extrusion assembly 107 and junction box 1 prior to inserting the temporary cover 720.

In the embodiment where the wall flange extrusion assembly 107 comprises a two-piece wall flange extrusion assembly 270, the two-piece wall flange extrusion assembly 270 is installed in or on a finished building surface material 4 such as wood that is prefinished in the following exemplary manner. In one embodiment, a recessed junction box 1 is affixed to the building structure, such as common 2×4 studs, utilizing standard construction techniques. The recessed junction box 1 is affixed such that the distance between the front of the junction box and the front of the finished building surface material 4 approximates, but is not less than, the distance from the rear surface 332 of the extrusion member 427 to the front surface 409 of the extrusion member 427. Second, all other rough construction work is completed that must be completed prior to installing the finished building surface material. Third, an aperture 10 is placed in the finished building surface material at the location for the recessed junction box 1. The dimensions of the aperture 10 must be equal to the outer dimensions of the extrusion member 427. Fourth, the two-piece wall flange extrusion assembly 270 is affixed to the rear surface of the finished building surface material by inserting the extrusion member 427 into the building surface material aperture 10 such that the front surface 409 of the extrusion member 427 is co-planar with the front surface of the building material 4 and connecting the mounting flange member 424 to the extrusion member 427 using the slots 426 on the mounting flange member 424 and the mounting posts 428 on the extrusion member 427 and then affixing the mounting flange member 424 to the rear face of the finished building surface material 4 utilizing adhesive or other fastening devices such as screws, nails or staples. Fifth, the finished building surface material 4 is installed utilizing the method appropriate for the finished building surface material 4. Sixth, a temporary cover 720 is inserted into the wall flange aperture 114 to protect the wall flange aperture 114 and any items in the junction box 1. Seventh, any required finish, such as paint or stain, is applied to the finished building surface material 4. Eighth, the temporary cover 720 is removed. Ninth, the receptacle 2 or other device, if applicable, is inserted into the two-piece wall flange extrusion assembly 270 and attached to the extrusion member 427 and junction box 1. Tenth, the cover 820 or device is installed in the extrusion aperture 414. Alternatively, the receptacle 2 or other device can be inserted into the extrusion member 427 and attached to the extrusion member 427 and junction box 1 prior to inserting the temporary cover 720.

In an embodiment where the two-piece wall flange extrusion assembly 270 is installed in a building surface that consists of a mounting substrate 4 and a finished building surface material 230 such as tile, referring to FIG. 10 for example, the installation of the two-piece wall flange extrusion assembly 270 is carried out as follows. First, a recessed junction box 1 is affixed to the building structure such as common 2×4 studs utilizing standard construction techniques. The recessed junction box 1 is affixed such that the distance between the front of the junction box 1 and the front of the finished building surface material 230 approximates, but is not less than, the distance from the rear surface 332 of the extrusion member 427 to the front surface 409 of the extrusion member 427. Second, all other rough construction work is completed that must be completed prior to installing the mounting substrate 204. Third, an aperture 10 is formed in the mounting substrate 204 at the appropriate location for the recessed junction box 1. The dimensions of the aperture 10 must be larger than the outer dimensions of the extrusion member 427 but smaller than the outer dimensions of the mounting flange member 424. Fourth, the mounting substrate 204 is affixed to the building structure utilizing standard construction techniques. Fifth, the mounting flange member 424 and the extrusion member 427 of the two-piece wall flange extrusion assembly 270 are connected using the extrusion mounting posts 428 and flange slots 426. Sixth, the two-piece wall flange extrusion assembly 270 is affixed to the mounting substrate 204 by affixing the extrusion member 427 to the junction box 1 utilizing screws inserted through the rear mounting flanges 112 of the extrusion member 427 and into the threaded holes that exist in standard recessed junction boxes. Seventh, the mounting flange member 424 is pressed against the mounting substrate 204 and affixed to the mounting substrate 204 utilizing adhesive or other fastening devices such as screws, nails or staples. Eighth, a temporary cover 720 is inserted into the wall flange aperture 414 to protect the extrusion member 427 and aperture 114. Ninth, the finished building surface material 230 is installed utilizing the method appropriate for the finished building surface material 230, such finished building surface material 230 being cut to provide an aperture equal to the exterior dimensions of the extrusion member 427 of the two-piece wall flange extrusion assembly 270 plus an amount equal to any desired space for the finishing material 232. Tenth, the finishing material 232, or other suitable material, is applied such that the finishing material 232 fills any gaps between the finished building surface material 230 and the two-piece wall flange extrusion assembly 270. Eleventh, the temporary cover 720 is removed. Twelfth, the receptacle 2 or other device, if applicable, is inserted into the two-piece wall flange extrusion assembly 270 and attached to the two-piece wall flange extrusion assembly 270 and junction box 1. Thirteenth, the final cover 820 or device is installed in the wall flange aperture 414. Alternatively, the receptacle 2 or other device can be inserted into the two-piece wall flange extrusion assembly 270 and attached to the two-piece wall flange extrusion assembly 270 and junction box 1 prior to inserting the temporary cover 720.

In an embodiment where the junction box 1 is integrated into the extrusion portion 118 of the wall flange extrusion assembly 107 of FIG. 2, the installation is generally the same as that described above except that no separate recessed junction box is installed. Instead, the wall flange extrusion assembly 107 with integrated junction box 1 is affixed to the building surface 4, mounting substrate 231 or finished building surface material 230, as appropriate, rather than to the junction box 1, utilizing adhesive or other fastening devices such as screws, nails or staples.

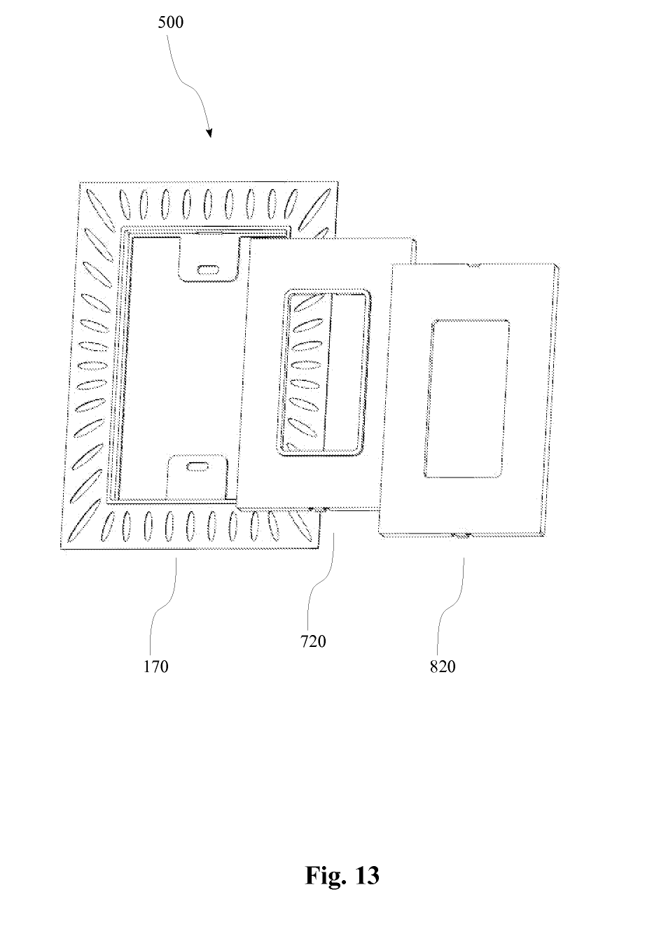

Referring to FIG. 13, in one embodiment, the wall plate assembly 100 of the present disclosure can be provided to users as individual pieces or as a kit 500. As shown in FIG. 13, the kit 500 can include one or more of the single piece wall flange extrusion assembly 170, one or more of the temporary cover 720 and one or more of the final cover 820. An instruction booklet or pamphlet can be provided that includes step-by-step instructions on how to mount the wall plate assembly 100 in or on a building structure, as shown in FIG. 2, for example. Alternatively, the step-by-step instructions can be provided in the form of a video including, but not limited to, an on-line video.

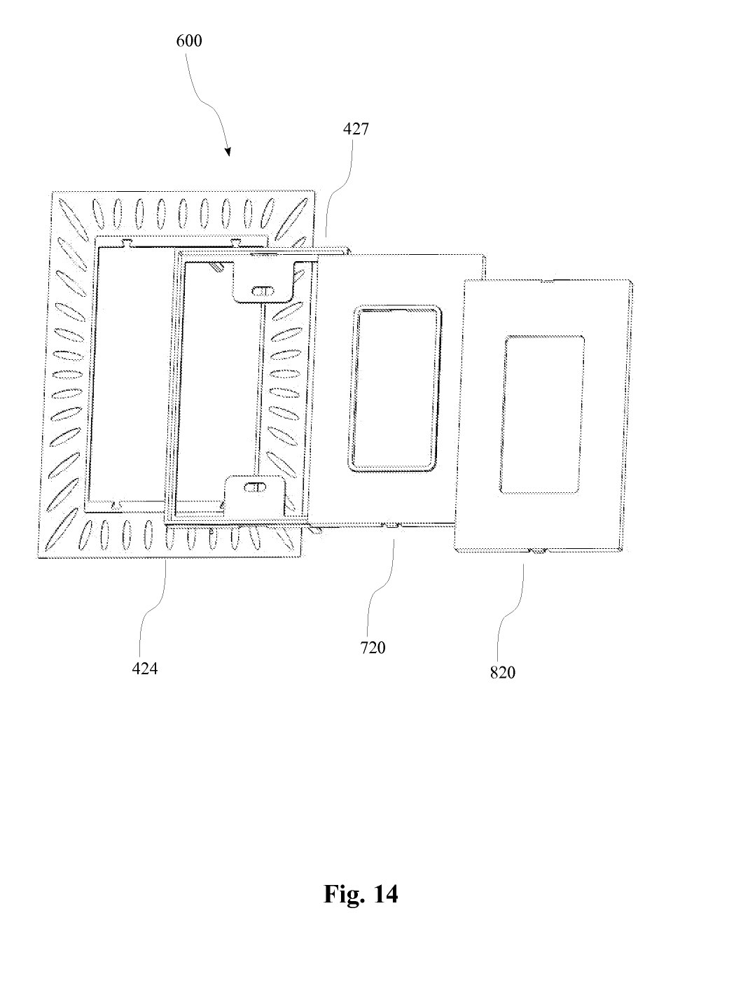

Referring to FIG. 14, in one embodiment, the wall plate assembly 100 of the present disclosure can be provided to users as individual pieces or as a kit 600. As shown in FIG. 14, the kit 600 can include one or more of the two-piece wall flange extrusion assembly 270 comprising one or more mounting flange member 424 and one or more extrusion member 427, one or more of the temporary cover 720 and one or more of the final cover 820. An instruction booklet or pamphlet can be provided that includes step-by-step instructions on how to mount the wall plate assembly in or on a building structure as shown in FIG. 9 or FIG. 10. Alternatively, the step-by-step instructions can be provided in the form of a video including, but not limited to, an on-line video.

Thus, while there have been shown, described and pointed out, fundamental novel features of the invention as applied to the exemplary embodiments thereof, it will be understood that various omissions and substitutions and changes in the form and details of devices illustrated, and in their operation, may be made by those skilled in the art without departing from the spirit and scope of the invention. Moreover, it is expressly intended that all combinations of those elements, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A flush-mount wall plate system for mounting in a building surface, comprising:
a wall flange extrusion assembly comprising a mounting flange portion and an extrusion member portion, the extrusion member portion having a frame defining an aperture and a front edge of the frame extending away from a front surface of the mounting flange portion by a pre-determined distance;
a cover inserted into the aperture, a front surface of the cover being substantially co-planar with the front edge of the extrusion member portion and the building surface.

2. The flush-mount wall plate system of claim 1, wherein the extrusion member portion comprises a stop member on a rear edge of the frame.

3. The flush-mount wall plate system of claim 1, wherein the extrusion member portion comprises a rear mounting flange disposed on and extending away from a rear edge of the frame into the aperture.

4. The flush-mount wall plate system of claim 1, wherein the mounting flange portion includes openings configured to secure the mounting flange portion to the building surface.

5. The flush-mount wall plate system of claim 1, wherein the extrusion member portion includes recesses in the frame for receiving mounting tabs of the cover.

6. The flush-mount wall plate system of claim 1, wherein the wall flange extrusion assembly comprises a single-piece, integrated assembly.

7. The flush-mount wall plate system of claim 1, wherein the wall flange extrusion assembly comprises a two-piece component assembly, and wherein the mounting flange portion and the extrusion member portion are configured to be removably coupled together.

8. The flush-mount wall plate system of claim 7, wherein the mounting flange portion and extrusion member portion are slidingly engaged.

9. The flush-mount wall plate system of claim 8, wherein the extrusion member portion comprises mounting posts and the mounting flange portion comprises slots for slidably receiving the mounting posts, wherein an end of the mounting posts extends into the aperture.

10. The flush-mount wall plate system of claim 9, wherein the mounting posts frictionally engage the slots.

11. The flush-mount wall plate system of claim 1, wherein the cover comprises a temporary cover with a raised flange portion on a front surface of the temporary cover, the raised flange portion defining a cover aperture that substantially aligns with the aperture in the extrusion member portion.

12. The flush-mount wall plate system of claim 1, wherein the cover comprise a final cover, the final cover having an opening therein that substantially aligns with the aperture in the extrusion member portion.

13. The flush-mount wall plate system of claim 1, comprising an electrical junction box integrated with the wall flange extrusion assembly.

14. The flush-mount wall plate system of claim 1, wherein the extrusion member is recessed within the mounting flange portion.

15. A method of mounting a wall plate system in a building surface, the wall plate system comprising a wall flange extrusion assembly comprising a mounting flange portion and an extrusion member portion, the extrusion member portion having a frame defining an aperture and a front edge of the frame extending away from a front surface of the mounting flange portion by a pre-determined distance, and a cover inserted into the aperture, a front surface of the cover being substantially co-planar with the front edge of the extrusion member portion and the building surface, the method comprising:
affixing the wall flange extrusion assembly over a junction box mounting aperture in the building surface;
mounting the cover over the aperture, the cover comprising a temporary cover with a raised flange portion on a front surface of the temporary cover surrounding an opening in the temporary cover that substantially aligns with the aperture;
blending the mounting flange portion of the wall flange extrusion assembly into the building surface, wherein the front edge of the frame of the extrusion member portion is substantially co-planar with the building surface;
removing the temporary cover; and
inserting the final cover into the aperture, a front surface of the final cover being substantially co-planar with the front edge of the frame of the extrusion member portion and the building surface.

16. The method of claim 15, comprising adjusting a position of the extrusion member portion relative to the mounting flange portion to accommodate a thickness of the building surface.

17. A kit of parts for installing a cover co-planar with a surface of a building structure, comprising:
a wall flange extrusion assembly comprising a mounting flange portion and an extrusion member portion, the extrusion member portion having a frame defining an aperture and a front edge of the frame extending away from a front surface of the mounting flange portion by a pre-determined distance; and
a cover configured to be inserted into the aperture.

18. The kit of claim 17, wherein the wall flange extrusion assembly is a single integrated assembly.

19. The kit of claim 17, wherein the wall flange extrusion assembly comprises a two-piece component assembly, and wherein the mounting flange portion and the extrusion member portion are configured to be removably coupled together.

20. The kit of claim 17, wherein the cover comprises a temporary cover and a final cover, the temporary cover having a raised flange portion on a front surface, the raised flange portion defining a cover aperture that substantially aligns with the aperture in the extrusion member portion, and wherein a surface of the final cover is substantially flat.
